(19) United States
(12) Patent Application Publication
(10) Pub. No.: US 2026/0142539 A1
(43) Pub. Date: May 21, 2026

(54) FIXING STRUCTURE

(71) Applicant: TOYOTA JIDOSHA KABUSHIKI KAISHA, Toyota-shi (JP)

(72) Inventor: Ayako HASEGAWA, Nagoya-shi (JP)

(73) Assignee: TOYOTA JIDOSHA KABUSHIKI KAISHA, Toyota-shi (JP)

(21) Appl. No.: 19/270,681

(22) Filed: Jul. 16, 2025

(30) Foreign Application Priority Data
Nov. 18, 2024 (JP) 2024-201051

(51) Int. Cl. H02K 11/25; G01K 1/14

(52) U.S. Cl. CPC H02K 11/25; G01K 1/14

(57) ABSTRACT

A fixing structure includes a case configured to accommodate a motor, a cover configured to cover the motor accommodated in the case, and a protrusion portion protruding from the cover toward a temperature measurement unit of the motor. In the fixing structure, the protrusion portion is configured to press the temperature sensor against the temperature measurement unit of the motor in a state where the cover is fixed to the case.

### CROSS-REFERENCE TO RELATED APPLICATION

This application claims priority to Japanese Patent Application No. 2024-201051 filed on Nov. 18, 2024. The disclosure of the above-identified application, including the specification, drawings, and claims, is incorporated by reference herein in its entirety.

### BACKGROUND

### 1. Technical Field

A technology disclosed in the present specification relates to a fixing structure.

### 2. Description of Related Art

Japanese Unexamined Patent Application Publication No. 2017-121126 (JP 2017-121126 A) discloses a fixing structure for fixing a temperature sensor to a temperature measurement unit of a motor. The fixing structure of JP 2017-121126 A includes a case that accommodates the motor and a bracket fixed to the case. The bracket has a first end portion fixed to the case and supports the temperature sensor at a second end portion. The temperature sensor is supported by the bracket in a state of being disposed in the temperature measurement unit of the motor.

### SUMMARY

In the fixing structure of JP 2017-121126 A, since the temperature sensor is supported by the bracket, a position of the temperature sensor with respect to the temperature measurement unit of the motor may be unstable. For example, the position of the temperature sensor with respect to the temperature measurement unit of the motor may vary due to vibration of the case to which the bracket is fixed. As a result, the temperature measurement accuracy of the temperature sensor may decrease. Therefore, the present specification provides a technology capable of improving the temperature measurement accuracy of the temperature sensor.

A first aspect of the present technology relates to a fixing structure for fixing a temperature sensor to a temperature measurement unit of a motor. The fixing structure includes

a case configured to accommodate the motor,
a cover configured to cover the motor accommodated in the case, and
a protrusion portion protruding from the cover toward the temperature measurement unit of the motor. In the fixing structure, the protrusion portion is configured to press the temperature sensor against the temperature measurement unit of the motor in a state where the cover is fixed to the case.

With the configuration, since the temperature sensor is pressed against the temperature measurement unit of the motor by the protrusion portion, it is possible to suppress the position of the temperature sensor with respect to the temperature measurement unit of the motor from being unstable. As a result, the temperature measurement accuracy of the temperature sensor can be improved.

In a second aspect, the fixing structure in the first aspect may further include an elastic member disposed between the protrusion portion and the temperature sensor.

In a third aspect, in the fixing structure in the first or second aspect, a recess portion may be provided at a rear end portion of the motor in an axial direction. A distal end portion of the temperature sensor may be disposed in the recess portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view schematically showing a fixing structure of an embodiment; and

FIG. 2 is a sectional view schematically showing a fixing structure of a modification.

### DETAILED DESCRIPTION OF EMBODIMENTS

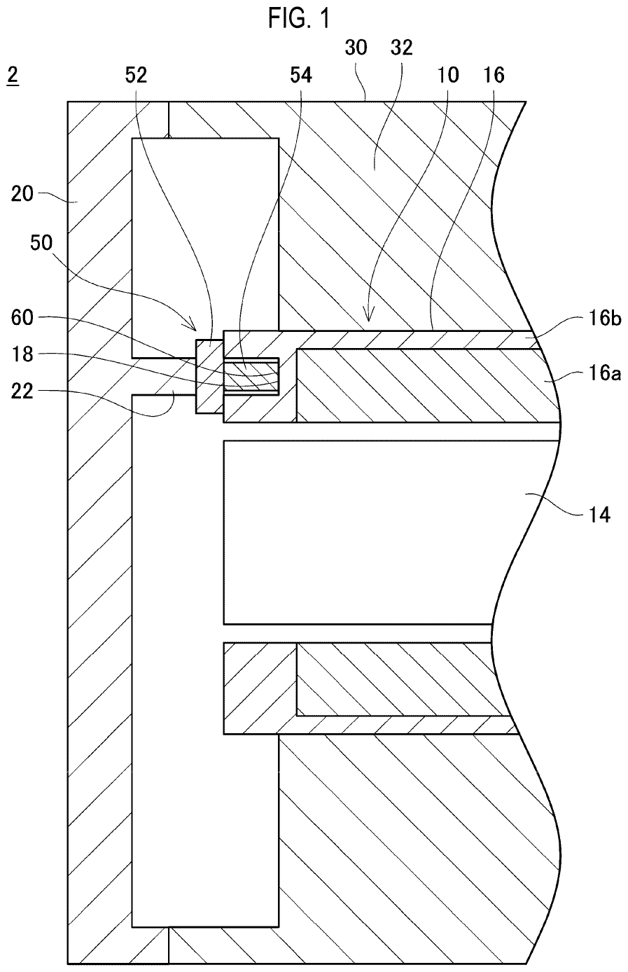

A fixing structure 2 of an embodiment will be described with reference to the drawings. As shown in FIG. 1, the fixing structure 2 of the embodiment includes a case 30 that accommodates a motor 10, a cover 20 that covers the motor 10 accommodated in the case 30, and a protrusion portion 22 that protrudes from the cover 20 toward a temperature measurement unit 60 of the motor 10. The fixing structure 2 is a structure for fixing the temperature sensor 50 to the temperature measurement unit 60 of the motor 10.

The motor 10 is not particularly limited, and is, for example, a motor for traveling mounted on a battery electric vehicle. The motor 10 may have a function as a generator. The motor 10 includes, for example, a rotor 14 and a stator 16 disposed around the rotor 14.

The stator 16 is fixed to the case 30 that accommodates the motor 10. The stator 16 includes a main body portion 16a and a resin portion 16b that coats the main body portion 16a. The main body portion 16a includes, for example, a coil and a core (both not shown). In the main body portion 16a, a magnetic force is generated in the core by the current flowing through the coil.

The resin portion 16b of the stator 16 coats the coil and the core of the main body portion 16a. The resin portion 16b has insulating properties. The resin portion 16b includes a recess portion 18 to which the temperature sensor 50 is attached. The recess portion 18 is formed by a part of the resin portion 16b being recessed in an axial direction of the motor 10. The recess portion 18 is provided at a rear end portion of the motor 10 in the axial direction. The recess portion 18 constitutes the temperature measurement unit 60 for measuring a temperature of the motor 10. In the present embodiment, the temperature measurement unit 60 of the motor 10 is provided in the resin portion 16b of the stator 16.

The rotor 14 of the motor 10 includes, for example, a permanent magnet (not shown), and is rotated by the magnetic force generated by the stator 16. Since the rotation principle of the rotor 14 is already known, a detailed description thereof will be omitted.

The case 30 that accommodates the motor 10 is made of, for example, metal. The case 30 supports the stator 16 of the motor 10 in a state of accommodating the motor 10. The case 30 includes a support portion 32 that supports the stator 16. The support portion 32 is disposed around the stator 16.

Next, the cover 20 will be described. The cover 20 is fixed to the case 30 in a state of covering the motor 10 accommodated in the case 30. The cover 20 is detachably attached to a rear end portion of the case 30 in the axial direction of the motor 10. The cover 20 covers the rear end portion of the motor 10 in the axial direction. In addition, the cover 20 covers the temperature sensor 50 that measures the temperature of the motor 10. The cover 20 is made of, for example, metal.

The cover 20 includes the protrusion portion 22 that protrudes toward the motor 10 accommodated in the case 30. The protrusion portion 22 is provided on the inner surface of the cover 20. The protrusion portion 22 protrudes from the inner surface of the cover 20 toward the rear end portion of the motor 10 in the axial direction. The protrusion portion 22 protrudes toward the temperature measurement unit 60 of the motor 10. The protrusion portion 22 protrudes from the rear end portion of the case 30 to a front side.

The protrusion portion 22 presses the temperature sensor 50 that measures the temperature of the motor 10 in a state where the cover 20 is attached to the case 30. In a case where the cover 20 is attached to the case 30, a distal end portion of the protrusion portion 22 is pressed against a base portion 52 of the temperature sensor 50. The protrusion portion 22 presses the temperature sensor 50 against the temperature measurement unit 60 of the motor 10. As a result, the temperature sensor 50 is fixed to the temperature measurement unit 60 of the motor 10.

The temperature sensor 50 includes the base portion 52 and a distal end portion 54 protruding from the base portion 52. The distal end portion 54 of the temperature sensor 50 is disposed in the recess portion 18 provided in the stator 16 of the motor 10. A distal end of the distal end portion 54 abuts a bottom of the recess portion 18. In a case where the cover 20 is fixed to the case 30, the temperature sensor 50 is fixed to the temperature measurement unit 60 of the motor 10 by the protrusion portion 22 of the cover 20. The temperature sensor 50 measures the temperature of the temperature measurement unit 60 of the motor 10 in a state of being pressed against the motor 10.

### Effect

Hereinbefore, the fixing structure 2 of the embodiment has been described. As is clear from the description, the fixing structure 2 includes the protrusion portion 22 that protrudes from the cover 20 toward the temperature measurement unit 60 of the motor 10. In the fixing structure 2, the protrusion portion 22 presses the temperature sensor 50 against the temperature measurement unit 60 of the motor 10 in a state where the cover 20 is fixed to the case 30.

With the configuration, since the temperature sensor 50 is pressed against the temperature measurement unit 60 of the motor 10 by the protrusion portion 22, it is possible to suppress the position of the temperature sensor 50 with respect to the temperature measurement unit 60 of the motor 10 from being unstable. As a result, the temperature measurement accuracy of the temperature sensor 50 can be improved.

In addition, the recess portion 18 is provided at the rear end portion of the motor 10 in the axial direction, and the distal end portion 54 of the temperature sensor 50 is disposed in the recess portion 18. With the configuration, the position of the temperature sensor 50 can be stabilized. As a result, the temperature measurement accuracy of the temperature sensor 50 can be improved.

### Modification

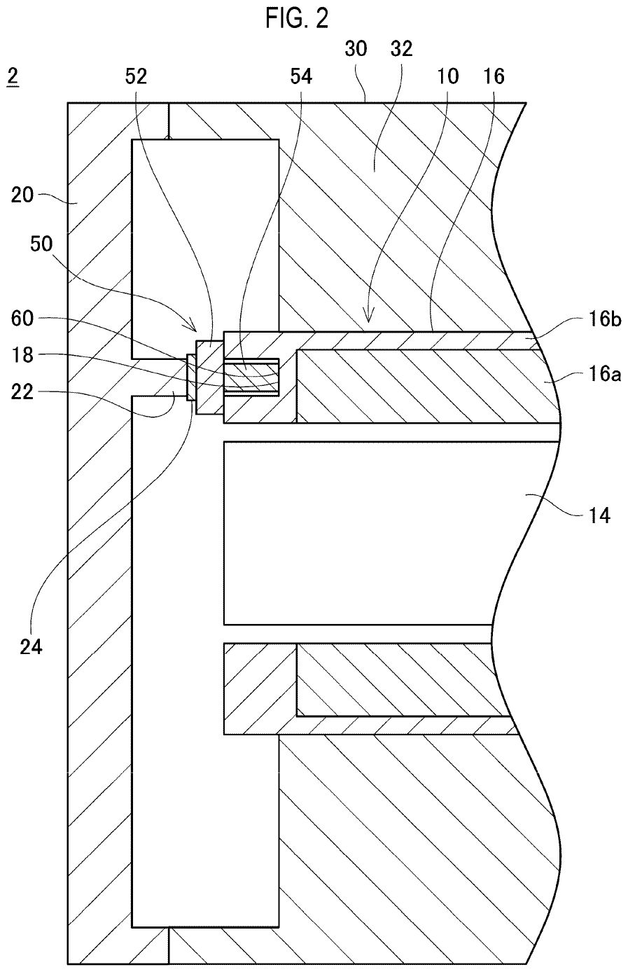

In a modification, as shown in FIG. 2, the fixing structure 2 may include an elastic member 24 attached to the distal end portion of the protrusion portion 22. The elastic member 24 is disposed between the distal end portion of the protrusion portion 22 and the base portion 52 of the temperature sensor 50. The protrusion portion 22 presses the temperature sensor 50 via the elastic member 24. In another modification, the elastic member 24 may be attached to the base portion 52 of the temperature sensor 50.

With the configuration, even in a case where the cover 20 is vibrated, the vibration of the cover 20 can be suppressed from being transmitted to the temperature sensor 50 by the elastic member 24 absorbing the vibration. As a result, the temperature measurement accuracy of the temperature sensor 50 can be improved.

In the embodiment, the temperature measurement unit 60 of the motor 10 is provided in the resin portion 16b of the stator 16, but the present disclosure is not limited to the configuration. The position of the temperature measurement unit 60 of the motor 10 is not particularly limited.

Although specific examples of the aspect of the disclosure have been described above in detail, the examples are merely illustrative and are not intended to limit the scope of the claims. The technology described in the claims includes various modifications and changes of the specific examples exemplified above. The technical elements described in the present specification or the drawings exhibit technical usefulness alone or in various combinations, and are not limited to the combinations described in the claims at the time of filing. Moreover, the technology exemplified in the present specification or the drawings can achieve a plurality of objectives at the same time, and achieving one of the objectives has technical usefulness.

What is claimed is:

1. A fixing structure for fixing a temperature sensor to a temperature measurement unit of a motor, the fixing structure comprising:
a case configured to accommodate the motor;
a cover configured to cover the motor accommodated in the case; and
a protrusion portion protruding from the cover toward the temperature measurement unit of the motor,
wherein the protrusion portion is configured to press the temperature sensor against the temperature measurement unit of the motor in a state where the cover is fixed to the case.

2. The fixing structure according to claim 1, further comprising an elastic member disposed between the protrusion portion and the temperature sensor.

3. The fixing structure according to claim 1, wherein:
a recess portion is provided at a rear end portion of the motor in an axial direction; and
a distal end portion of the temperature sensor is disposed in the recess portion.
